(19) United States
(12) Patent Application Publication
(10) Pub. No.: US 2026/0253371 A1
(43) Pub. Date: Aug. 27, 2026

(54) IMAGE COMPENSATION METHOD, COMPUTER DEVICE, READABLE STORAGE MEDIUM, AND PROGRAM PRODUCT

(71) Applicant: Glenfly Tech Co., Ltd., Shanghai (CN)

(72) Inventors: Jianhong PAN, Shanghai (CN); Long HUANG, Shanghai (CN); Kun YANG, Shanghai (CN)

(21) Appl. No.: 19/259,442

(22) Filed: Jul. 3, 2025

(30) Foreign Application Priority Data
Feb. 21, 2025 (CN) 202510199990.4

(51) Int. Cl. G06V 10/60; G06T 5/20; G06T 7/60; G06T 9/00

(52) U.S. Cl. CPC G06V 10/60; G06T 5/20; G06T 7/60; G06T 9/00

(57) ABSTRACT

The present disclosure relates to an image compensation method, a computer device, a computer-readable storage medium, and a computer program product. The method includes: obtaining an image to be processed; calculating reference filtering parameters of each pixel in the image to be processed based on a positional relation between each pixel and reference pixels corresponding to each pixel; determining a display state of each pixel based on brightness differences between each pixel and adjacent pixels; constructing a target filter for each pixel based on the display state and the reference filtering parameters; and adjusting a brightness value of each pixel through the target filter.

### CROSS-REFERENCE TO RELATED APPLICATIONS

The present application claims priority to Chinese patent application No. 2025101999904, filed on Feb. 21, 2025, the entire content of which is incorporated herein by reference.

### TECHNICAL FIELD

The present disclosure relates to the field of image processing technologies, and in particular, to an image compensation method, a computer device, a computer-readable storage medium, and a computer program product.

### BACKGROUND

With the rapid development of display technology, active-matrix organic light-emitting diode (AMOLED) display technology has gradually become mainstream.

AMOLED panels are popular with consumers because of their excellent properties such as self-luminescence, wide color gamut, fast response, high brightness, and high contrast. Due to the different lifespans of sub-pixel materials, in order to extend the lifespan, triangular pixel arrangements are commonly used instead of the traditional matrix-stripe arrangement. However, this approach may cause color fringing and jagged phenomena during display, which will affect the image display quality.

### SUMMARY

In a first aspect, the present disclosure provides an image compensation method, including:
obtaining an image to be processed;
calculating reference filtering parameters of each pixel in the image to be processed based on a positional relation between each pixel and reference pixels corresponding to each pixel;
determining a display state of each pixel based on brightness differences between each pixel and adjacent pixels;
constructing a target filter for each pixel based on the display state and the reference filtering parameters; and
adjusting a brightness value of each pixel through the target filter.

In an embodiment, calculating the reference filtering parameters of each pixel in the image to be processed based on the positional relation between each pixel and the reference pixels corresponding to each pixel includes:
determining the reference pixels corresponding to each pixel; and
calculating geometric distances from a geometric center of each sub-pixel in each pixel to a geometric center of the current pixel and a geometric center of each of the reference pixels, respectively, to obtain the reference filtering parameters.

In an embodiment, calculating the geometric distances from the geometric center of each sub-pixel in each pixel to the geometric center of the current pixel and the geometric center of each of the reference pixels, respectively, to obtain the reference filtering parameters includes:
calculating a weighted distance corresponding to each sub-pixel based on the geometric distances from the geometric center of each sub-pixel in each pixel to the geometric center of the current pixel and the geometric center of each of the reference pixels; and
obtaining the reference filtering parameters based on a proportion of the geometric distance from each sub-pixel in each pixel to the current pixel in the weighted distance.

In an embodiment, calculating the geometric distances from the geometric center of each sub-pixel in each pixel to the geometric center of the current pixel and the geometric center of each of the reference pixels, respectively, to obtain the reference filtering parameters includes:
when an arrangement of sub-pixels in the current pixel is different from an arrangement of sub-pixels in each of the reference pixels, calculating distances from each sub-pixel in each pixel at a first preset position to the geometric center of the current pixel and the geometric center of each of the reference pixels, respectively, and calculating distances from each sub-pixel in each pixel at a second preset position to the geometric center of the current pixel and the geometric center of each of the reference pixels, respectively, to obtain the reference filtering parameters.

In an embodiment, determining the display state of each pixel based on the brightness differences between each pixel and the adjacent pixels includes:
calculating the brightness differences between each pixel and the adjacent pixels in a preset direction, the adjacent pixels being determined based on a preset pixel window; and
performing encoding according to the brightness differences to obtain encoding information, and obtaining the display state based on the encoding information.

In an embodiment, performing encoding according to the brightness differences to obtain the encoding information, and obtaining the display state based on the encoding information includes:
comparing the brightness differences with a preset threshold to obtain difference information;
performing encoding on each pixel and the adjacent pixels corresponding to each pixel based on the difference information to obtain the encoding information; and
comparing the encoding information with preset encoding information to obtain the display state.

In an embodiment, constructing the target filter for each pixel based on the display state and the reference filtering parameters includes:
obtaining a first original filter;
adjusting the first original filter according to the display state to obtain a first initial filter;
selecting first target filtering parameters from the reference filtering parameters based on the first initial filter; and
obtaining the target filter according to the first initial filter and the first target filtering parameters.

In an embodiment, the first original filter includes a first-order filter and a third-order filter, and adjusting the first original filter according to the display state to obtain the first initial filter includes:
selecting the first-order filter as the first initial filter when the display state is an edge-shaped anomaly;
selecting the third-order filter as the first initial filter when the display state is a jagged anomaly; and
selecting the first-order filter and the third-order filter as the first initial filter when the display state is neither the edge-shaped anomaly nor in the jagged anomaly.

In an embodiment, selecting the first target filtering parameters from the reference filtering parameters based on the first initial filter includes:
selecting initial filtering parameters from the reference filtering parameters based on a structure of the first initial filter; and
selecting the first target filtering parameters from the initial filtering parameters based on an arrangement of sub-pixels in each pixel.

In an embodiment, constructing the target filter for each pixel based on the display state and the reference filtering parameters includes:
obtaining a second original filter;
obtaining a second initial filter based on the second original filter and the reference filtering parameters; and
adjusting the second initial filter according to the display state to obtain the target filter.

In an embodiment, the second original filter includes a first-order filter and a third-order filter, and adjusting the second initial filter according to the display state to obtain the target filter includes:
selecting the first-order filter as the second initial filter when the display state is an edge-shaped anomaly;
selecting the third-order filter as the second initial filter when the display state is a jagged anomaly; and
selecting the first-order filter and the third-order filter as the second initial filter when the display state is neither the edge-shaped anomaly nor in the jagged anomaly.

In an embodiment, obtaining the second initial filter based on the second original filter and the reference filtering parameters includes:
selecting second initial filtering parameters from the reference filtering parameters based on an arrangement of sub-pixels in each pixel; and
obtaining the second initial filter based on the original filter and the second initial filtering parameters.

An image compensation apparatus is provided, including:
an obtaining module configured to obtain an image to be processed;
a parameter calculation module configured to calculate reference filtering parameters of each pixel in the image to be processed based on a positional relation between each pixel and reference pixels corresponding to each pixel;
a display determination module configured to determine a display state of each pixel based on brightness differences between each pixel and adjacent pixels;
a filter construction module configured to construct a target filter for each pixel based on the display state and the reference filtering parameters; and
a compensation module configured to adjust a brightness value of each pixel through the target filter.

A computer device is provided, including a memory and a processor. The memory stores a computer program, and the processor, when executing the computer program, implements steps of any method described above.

A non-transitory computer-readable storage medium is provided, having a computer program stored thereon. When the computer program is executed by a processor, steps of any method described above are implemented.

A computer program product is provided, including a computer program. When the computer program is executed by a processor, steps of any method described above are implemented.

### BRIEF DESCRIPTION OF THE DRAWINGS

In order to describe the technical solutions of the embodiments of the present disclosure or the related art more clearly, the accompanying drawings required for describing the embodiments of the present disclosure or for describing the related art will be briefly introduced as follows. Apparently, the accompanying drawings, in the following description, illustrate merely some embodiments of the present disclosure, for a person of ordinary skill in the art, other drawings can also be obtained according to these accompanying drawings without making any creative efforts.

FIG. 1 is a schematic diagram showing a matrix stripe arrangement in an embodiment.

FIG. 2 is a schematic diagram showing a triangular arrangement in an embodiment.

FIG. 3 is a schematic diagram showing a triangular arrangement in another embodiment.

FIG. 4 is a schematic flow chart of an image compensation method in an embodiment.

FIG. 5 is a schematic diagram showing a preset pixel window in an embodiment.

FIG. 6 is a schematic diagram showing another arrangement in an embodiment.

FIG. 7 is a schematic diagram showing reference pixels in another embodiment.

FIG. 8 is a schematic diagram of calculating a geometric distance in an embodiment.

FIG. 9 is a schematic diagram of calculating a geometric distance in another embodiment.

FIG. 10 is a schematic diagram showing an edge-shaped arrangement in an embodiment.

FIG. 11 is a schematic diagram showing a jagged-shaped arrangement in an embodiment.

FIG. 12 is a schematic diagram showing other display states in an embodiment.

FIG. 13 is a schematic diagram showing a configuration of a 1×3 filter in an embodiment.

FIG. 14 is a schematic diagram showing a configuration of a 3×3 filter in another embodiment.

FIG. 15 is a block diagram showing a configuration of an image compensation apparatus in an embodiment.

FIG. 16 is a diagram showing an internal configuration of a computer device in an embodiment.

### DETAILED DESCRIPTION OF THE EMBODIMENTS

In order to make the objectives, technical solutions and advantages of the present disclosure more clearly understood, the present disclosure will be further described in detail with the accompanying drawings and embodiments. It should be understood that the specific embodiments described herein are only used to explain the present disclosure and not to limit the present disclosure.

It will be understood that the terms “first”, “second”, etc. used in this disclosure may be used herein to describe various elements, but these elements are not limited by these terms. These terms are only used to distinguish a first element from another element.

In the description of the present disclosure, it should be understand that if terms such as “center”, “longitudinal”, “lateral”, “length”, “width”, “thickness”, “top”, “bottom”, “front”, “back”, “left”, “right”, “vertical”, “horizontal”, “top”, “bottom”, “inner”, “outer”, “clockwise”, “counterclockwise”, “axial”, “radial”, “circumferential”, etc., are used, these terms indicate orientations or positional relationships as shown in the drawings, and are used for the purpose of describing the present disclosure and simplifying the description, not indicating or implying that the described devices or components must have specific orientations, be constructed and operated in specific orientations. Therefore, these terms should not be interpreted as limitations on the present disclosure.

As used herein, the singular forms “a” “an” and “this/the” may also include plural forms, unless otherwise clearly indicated. It should also be understood that the terms “includes/contains” or “have” etc. indicate the existence of the stated features, wholes, steps, operations, components, parts or combinations thereof. However, these terms do not exclude the possibility of the existence of one or more other features, wholes, steps, operations, components, parts or combinations thereof.

In AMOLED panels, due to the different lifespans of sub-pixel materials, in order to improve the lifespan, triangular pixel arrangements are commonly used instead of the traditional matrix-stripe arrangement. However, when displaying images with obvious edge details of text, color fringing and jagged phenomena will appear. The color fringing refers to a circle of colored bright spots around the edge, and the jagged phenomena refers to curved and jittery lines, which seriously affect the user's visual experience.

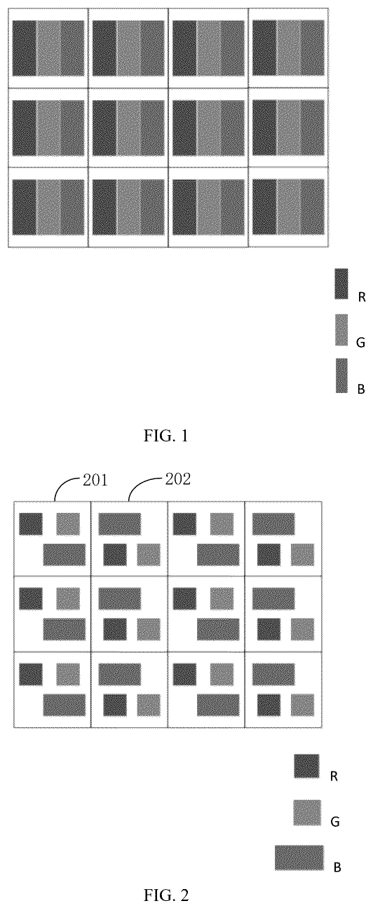

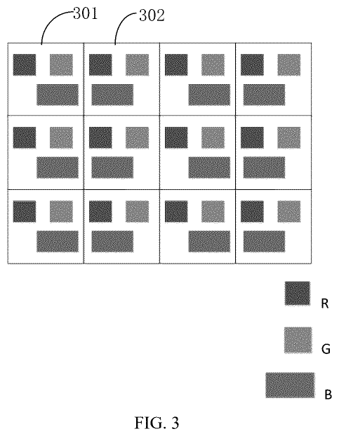

Exemplarily, with reference to FIG. 1, FIG. 2 and FIG. 3, FIG. 1 is a schematic diagram showing a matrix stripe arrangement in an embodiment. Each pixel in FIG. 1 is consist of a red sub-pixel R, a green sub-pixel G, and a blue sub-pixel B, which are arranged in sequence in a horizontal direction to form a regular stripe structure. The sub-pixels are aligned exactly in each row and column. FIG. 2 is a schematic diagram showing a triangular arrangement in an embodiment. The sub-pixels in FIG. 2 are arranged in a triangular form, presenting a more compact distribution. FIG. 3 is a schematic diagram showing a triangular arrangement in another embodiment.

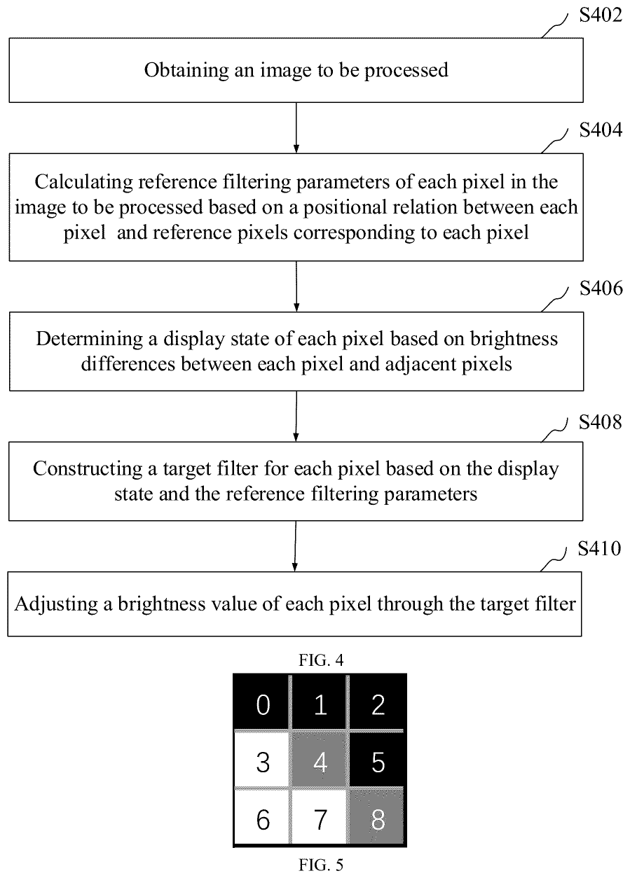

To solve the display problems caused by the triangular pixel arrangements, in this embodiment, as shown in FIG. 4, an image compensation method is provided. This embodiment is described by applying the method to a terminal. It can be understood that the method can also be applied to a server, or a system including a terminal and a server, and can be implemented through interaction between the terminal and the server. In the present embodiment, the method includes the following steps.

In the step 402, an image to be processed is obtained. The image to be processed includes a plurality of pixel blocks.

The image to be processed refers to a target image that needs to be optimized for display quality. Exemplarily, for the AMOLED display technology, the image to be processed is typically an image that a display device is ready to present to a user in the current frame buffer. The image to be processed may be consist of multiple pixels, and the brightness and color of each pixel are presented by the light emission of sub-pixels R, G, and B.

In the step 404, reference filtering parameters of each pixel are calculated based on a positional relation between each pixel in the image to be processed and reference pixels corresponding to each pixel.

First, the reference pixels used for calculating the reference filtering parameters are determined for each pixel, and the reference pixels corresponding to the respective pixels are different. The reference pixels refer to pixels that are used in the filtering process of the current pixel.

After the reference pixels are determined, the reference filtering parameters of each pixel are calculated based on each pixel and the reference pixels corresponding to each pixel. The reference filtering parameters include multiple groups of filtering parameters, which are applicable to different filter structures.

In image processing, filtering parameters generally reflect the correlation between the current pixel and the reference pixels used in filtering. One of the most direct ways to measure the correlation between two pixels is their positional relation.

Optionally, the reference filtering parameters of each pixel can be calculated based on distances between each pixel and the reference pixels corresponding to each pixel.

Optionally, the closer the distance between the current pixel and the reference pixel is, the larger the corresponding reference filtering parameter is, and vice versa.

Optionally, the positional relation between each sub-pixel in each pixel and the reference pixels corresponding to each pixel can be calculated to calculate the reference filtering parameters of each pixel.

Further, the reference filtering parameters include multiple groups of filtering parameters, and the multiple groups of filtering parameters are calculated based on different reference pixels. Different reference pixels may be selected based on a preset filter structure. Exemplarily, the preset filter structure may be a 1×3 filter structure (also referred to as a first-order filter) or a 3×3 filter structure (also referred to as a third-order filter). Different reference pixels may be obtained based on different filter structures.

In the step 406, a display state of each pixel is determined based on brightness differences between each pixel and adjacent pixels.

The adjacent pixels refer to pixels used to determine the display state corresponding to each pixel, which can be determined by a preset pixel window. Exemplarily, with reference to FIG. 5, FIG. 5 is a schematic diagram showing a preset pixel window in an embodiment.

Each pixel and its corresponding adjacent pixels can be regarded as a pixel block. The display state of the pixel in the pixel block can be determined based on the brightness differences between each pixel and the adjacent pixels in the pixel block. The brightness value of each pixel is a combination of the luminous intensity of sub-pixels of each pixel, and the arrangement of sub-pixels determines the spatial distribution of brightness and luminous efficiency. Therefore, the arrangement of sub-pixels will affect the brightness value of the pixel. Different arrangements will result in brightness differences between the pixel and the adjacent pixels. Therefore, by calculating the brightness differences between each pixel and its neighboring pixels, the display state of the pixel can be further determined.

Furthermore, the display state includes an edge-shaped anomaly and a jagged anomaly. The edge-shaped anomaly refers to the color fringing mentioned in the above embodiment, which is caused by excessive brightness difference in a single direction. The color fringing manifests as a certain color standing out in the edge area, forming an obvious color halo, and generally occurs when the sub-pixels are arranged too densely in a certain direction. The jagged anomaly is caused by excessive brightness difference in multiple directions, which manifests as a step-like discontinuous effect on the edges of diagonal lines or curves. The jagged anomaly generally occurs when the sub-pixels are arranged irregularly in multiple directions.

In the step 408, a target filter for each pixel is constructed based on the display state and the reference filtering parameters.

The target filter refers to a final filter that can perform a specific operation on the pixel, and the target filter includes specific parameters for filtering an image.

With reference to the description in the above embodiments, the display state may be in the edge shape or the jagged shape, so for accurate compensation, it is necessary to adjust the structure of a first original filter based on the display state, and then obtain the target filter based on the adjusted first original filter and the reference filtering parameters. The first original filter is a mixture of filters of multiple preset filter structures.

Optionally, the reference filtering parameters include multiple groups of filtering parameters as described above, so after the display state is determined, based on the display state, any one group is selected from the reference filtering parameter as a target filtering parameter or multiple groups of filtering parameters are merged to be the target filtering parameter.

Exemplarily, since the edge-shaped anomaly is caused by the excessive density of sub-pixels arranged in a single direction, a filter in the single direction, such as a first-order filter, can be constructed based on the first original filter to perform smoothing on the brightness in a specific direction.

Exemplarily, since the jagged anomaly refers to an irregular arrangement of sub-pixels in multiple directions, a comprehensive filter, such as a third-order filter, can be constructed based on the first original filter to ensure a natural brightness transition in multiple directions.

In the step 410, a brightness value of each pixel is adjusted through the target filter.

Optionally, the target filter reallocates the brightness value of the pixel based on the relationship between the pixel and its adjacent pixels, so as to adjust the brightness value of each pixel, thereby compensating each pixel in the image to be processed.

Optionally, the filter window may be moved to perform a convolution operation on the current sub-pixel, thereby adjusting the brightness value of each pixel.

Through the target filter, a grayscale value of the sub-pixel is closely related to a grayscale value of the sub-pixel of the adjacent unit, thereby effectively solving the problems of color fringing and jagged edges caused by the arrangement of sub-pixels, thereby improving the display effect of the display panel.

In the image compensation method as described above, the reference filtering parameters are first determined based on the positional relation between each pixel and the corresponding reference pixels, and the display state is determined based on the brightness differences between each pixel and the adjacent pixels. After the display state is determined, the corresponding target filter is constructed for each pixel based on the display state and the reference filtering parameters, so that the brightness value of each pixel is accurately adjusted through the target filter, thereby achieving accurate compensation of the image to be processed.

In an embodiment, calculating the reference filtering parameters of each pixel based on the positional relation between each pixel in the image to be processed and the reference pixels corresponding to each pixel includes: determining the reference pixels corresponding to each pixel; calculating geometric distances from a geometric center of each sub-pixel in each pixel to a geometric center of the current pixel and a geometric center of each of the reference pixels, respectively, to obtain the reference filtering parameters.

Optionally, the reference pixels corresponding to each pixel may be determined through the preset filter structure. For example, a preset sliding window is preset based on the preset filter structure, and then the preset sliding window is slid on the image to be processed to determine the reference pixels corresponding to each pixel.

Further, the preset filter structure may include two structures: a 1×3 filter and a 3×3 filter. The 1×3 filter can effectively solve the color fringing problem of the text, and the 3×3 filter can effectively solve the jagged shape problem such as curved and jittery lines.

Exemplarily, with reference to FIG. 5, the preset pixel window in FIG. 5 includes 9 pixels. Assuming that the reference pixels corresponding to the pixel numbered “0” are currently to be determined, and the preset sliding window is a 3×3 matrix, the reference pixels are the three pixels numbered “1”, “3” and “4”. If the reference pixels corresponding to the pixel numbered “1” are currently to be determined, and the preset sliding window is a 3×3 matrix, the reference pixels are the five pixels numbered “0”, “2”, “3”, “4” and “5”. In other words, when there is a region beyond the display region in the edge pixel region, padding needs to be performed on the region beyond the display region.

It should be noted that the current pixel needs to be located at the center of the preset sliding window.

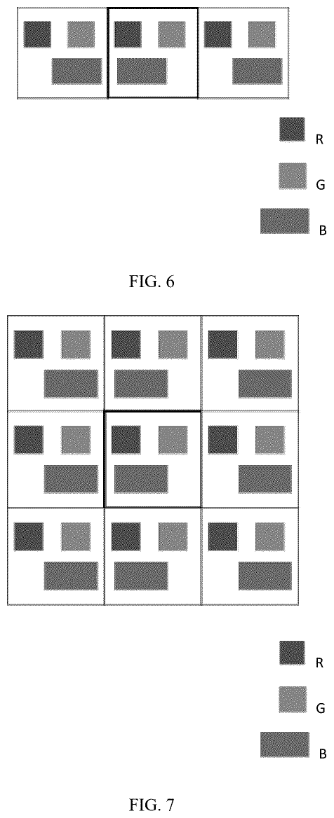

Exemplarily, with reference to FIG. 6, FIG. 6 is a schematic diagram showing reference pixels in an embodiment. The preset filter structure in FIG. 6 is the 1×3 filter structure. The pixel in the middle of the three pixels is the current pixel. In this case, the left and right neighboring pixels of the current pixel are taken as the reference pixels.

Exemplarily, with reference to FIG. 7, FIG. 7 is a schematic diagram showing reference pixels in another embodiment. The preset filter structure in FIG. 7 is the 3×3 filter structure. The pixel in the center of the nine pixels is the current pixel. In this case, a total of 8 pixels above, below, left, right, and diagonally of the current pixel are taken as the reference pixels.

In this embodiment, after the reference pixels corresponding to each pixel are determined, the geometric distances from the geometric center of the sub-pixel in each pixel to the geometric center of the current pixel and the geometric center of each of the reference pixels are calculated respectively, so as to obtain the reference filtering parameters based on the geometric distances.

Exemplarily, with reference to FIG. 8, FIG. 8 is a schematic diagram of calculating a geometric distance in an embodiment. In FIG. 8, taking a red sub-pixel as an example, the distances from the geometric center of the red sub-pixel to the geometric center of the current pixel and the geometric center of each of the reference pixels are calculated, respectively.

Exemplarily, with reference to FIG. 9, FIG. 9 is a schematic diagram of calculating a geometric distance in another embodiment. In FIG. 9, taking a red sub-pixel as an example, the distances from the geometric center of the red sub-pixel to the geometric center of the current pixel and the geometric center of each of the reference pixels are calculated, respectively.

In this way, the geometric distances from each sub-pixel in each pixel to the current pixel and each reference pixel under different preset filter structures can be calculated according to the above method to obtain the reference filtering parameters.

The filtering parameters are calculated based on the geometric distances of the sub-pixel, which can reflect the spatial arrangement and brightness influence range between the sub-pixels. The closer the sub-pixel is, the greater the influence of the sub-pixel on the brightness of the current pixel, so the sub-pixel will be given a higher weight by the filter. In this way, different sub-pixel arrangements can be adapted, local brightness distribution can be optimized, the display problem can be accurately compensated, and excessive or insufficient brightness adjustment can be avoided.

Further, calculating the geometric distances from the geometric center of each sub-pixel in each pixel to the geometric center of the current pixel and the geometric center of each of the reference pixels, respectively, to obtain the reference filtering parameters includes: calculating a weighted distance corresponding to each sub-pixel based on the geometric distances from the geometric center of each sub-pixel in each pixel to the geometric center of the current pixel and the geometric center of each of the reference pixels; and obtaining the reference filtering parameters based on a proportion of the geometric distance from each sub-pixel in each pixel to the current pixel in the weighted distance.

Exemplarily, with reference to the example in FIG. 8, taking the red sub-pixel as an example, the geometric distance from the red sub-pixel to the current pixel is denoted as

$$\frac{1}{d i s {t}_{c}} ,$$

and the geometric distances from the red sub-pixel to the reference pixels are denoted as

$$\frac{1}{d i s {t}_{1}} and \frac{1}{{dist}_{r}}$$

respectively, then the weighted distance corresponding to the sub-pixel is equal to

$$\frac{1}{d i s {t}_{c}} + \frac{1}{d i s {t}_{1}} + \frac{1}{{dist}_{r}} .$$

Then, based on the proportion of the geometric distance from the sub-pixel to the current pixel in the weighted distance, the weight Wc of the current sub-pixel is obtained, as shown in formula (1).

$$Wc = \frac{\frac{1}{d i s {t}_{c}}}{\frac{1}{d i s {t}_{1}} + \frac{1}{d i s {t}_{c}} + \frac{1}{{dist}_{r}}} \qquad Formula ( 1 )$$

In this way, the weights of different sub-pixels in the current pixel are calculated respectively, and the filtering parameters corresponding to the current pixel can be obtained. Exemplarily, the filtering parameters are denoted as follows:

$${filter}_{1 \times 3}^{R} = [ \begin{matrix}0.16 & 0.78\end{matrix} 0.06 ]$$

$${filter}_{1 \times 3}^{G} = [ \begin{matrix}0.06 & 0.78\end{matrix} 0.16 ]$$

$${filter}_{1 \times 3}^{R} = [ \begin{matrix}0.16 & 0.88\end{matrix} 0.06 ]$$

According to the example in this embodiment, the filtering parameters corresponding to each pixel can be obtained.

Exemplarily, with reference to the example in FIG. 9, the weight of the sub-pixel at the upper left corner is shown in formula (2):

$$\qquad Formula ( 2 )$$

$${w}_{u l} = \frac{\frac{1}{{dist}_{ul}}}{\frac{1}{d i s {t}_{lu}} + \frac{1}{d i s {t}_{u}} + \frac{1}{d i s {t}_{r u}} + \frac{1}{{dist}_{l}} + \text{} \frac{1}{d i s {t}_{c}} + \frac{1}{d i s {t}_{r}} + \frac{1}{d i s {t}_{ld}} + \frac{1}{d i s {t}_{d}} + \frac{1}{d i s {t}_{r d}}}$$

Then, the filtering parameters corresponding to the current pixel are denoted as follows:

$${filter}_{3 \times 3}^{R} = [ \begin{matrix}066 & 0.11 & 0.03 \\ 0.11 & 0.56 & 0.04 \\ 003 & 0.04 & 0.02\end{matrix} ]$$

$${filter}_{3 \times 3}^{G} = [ \begin{matrix}0.03 & 0.11 & 0.06 \\ 0.04 & 0.56 & 0.11 \\ 0.02 & 0.04 & 0.03\end{matrix} ]$$

$${filter}_{3 \times 3}^{B} = [ \begin{matrix}0.02 & 0.03 & 0.02 \\ 0.04 & 0.71 & 0.04 \\ 0.03 & 0.08 & 0.03\end{matrix} ]$$

Thus, according to formula (1) and formula (2), the filtering parameters corresponding to each pixel can be obtained when the preset filter includes the 1×3 filter and the 3×3 filter. In this embodiment, the reference filtering parameters include first-order filtering parameters corresponding to the case where the preset filter is the 1×3 filter and third-order filtering parameters corresponding to the case where the preset filter is the 1×3 filter.

Further, calculating the geometric distances from the geometric center of each sub-pixel in each pixel to the geometric center of the current pixel and the geometric center of each of the reference pixels, respectively, to obtain the reference filtering parameters, includes: when an arrangement of sub-pixels in the current pixel is different from an arrangement of sub-pixels in each of the reference pixels, calculating distances from each sub-pixel in each pixel at a first preset position to the geometric center of the current pixel and the geometric center of each of the reference pixels, respectively, and calculating distances from each sub-pixel in each pixel at a second preset position to the geometric center of the current pixel and the geometric center of each of the reference pixels, respectively, to obtain the reference filtering parameters.

In this embodiment, the arrangement of sub-pixels is further considered. If the arrangement of sub-pixels in the pixel is different from the arrangement of sub-pixels in the reference pixels, it is necessary to calculate the geometric distances corresponding to the sub-pixel distributed at different positions.

Exemplarily, with reference to the first pixel 201 and the second pixel 202 in FIG. 2, the placement positions of the sub-pixels in the first pixel and the second pixel are different, thus it is determined that the arrangement of sub-pixels in the first pixel is different from the arrangement of sub-pixels in the second pixel. With reference to the first pixel 301 and the second pixel 302 in FIG. 3, the placement positions of the sub-pixels in the first pixel and the second pixel are the same, thus it is determined that the arrangement of sub-pixels in the first pixel is the same as the arrangement of sub-pixels in the second pixel.

The first preset position may be an even row or an even column, and the second preset position may be an odd row or an odd column.

In this embodiment, it is necessary to calculate the geometric distances corresponding to the case where the sub-pixels are located at the first preset position and the second preset position, respectively, and then calculate the reference filtering parameters based on the geometric distances. The method of calculating the geometric distances and the reference filtering parameters based on the geometric distances is the same as the calculation method in the above embodiment, and will not be repeated here.

With reference to the examples in the above embodiment, in this embodiment, the first-order filtering parameters and the third-order filtering parameters each correspond to two groups of parameters. Exemplarily, the first-order filtering parameters include a first first-order filtering parameter and a second first-order filtering parameter, and the third-order filtering parameters include a first third-order filtering parameter and a second third-order filtering parameter, which respectively represent the filtering parameters corresponding to the case where the sub-pixel is located at the first preset position and the second preset position. For example, the first first-order filtering parameter and the first third-order filtering parameter correspond to the first preset position, and the second first-order filtering parameter and the second third-order filtering parameter correspond to the second preset position.

Exemplarily, the weights of the red sub-pixels in the even columns are shown in Table 1:

TABLE 1
Even column

| | | |
|---|---|---|
| 0.06 | 0.11 | 0.03 |
| 0.11 | 0.56 | 0.04 |
| 0.03 | 0.04 | 0.02 |

The weights of the red sub-pixels in the odd columns are shown in Table 2:

TABLE 2
Odd column

| | | |
|---|---|---|
| 0.03 | 0.04 | 0.02 |
| 0.11 | 0.56 | 0.04 |
| 0.06 | 0.11 | 0.03 |

With reference to FIG. 9, the reason why the configurations of the weights in the odd column and the even column are different is that the distances from different adjacent sub-pixels to the sub-pixel are significantly different. For example, the distance from the red sub-pixel at the upper left corner of the even column to the central red sub-pixel is significantly smaller than the distance from the red sub-pixel at the upper left corner of the odd column to the central red sub-pixel.

In addition, it should be noted that when determining the reference pixels in the above embodiment, if there is a region beyond the display region in the edge pixel region, padding needs to be performed on the region beyond the display region. For the pixel in the padding part, the corresponding reference filtering parameters are 0.

Exemplarily, the parameter configuration of the central sub-pixel under the 3×3 filter is shown in Table 3, and the weight configuration of the sub-pixels at the four corners and edges is shown in the following Table:

TABLE 3

| | | | |
|---|---|---|---|
| Upper left | Lower left | Upper right | Lower right |
| corner | corner | corner | corner |

| | | | | | | | |
|---|---|---|---|---|---|---|---|
| 0.56 | 0.04 | 0.11 | 0.03 | 0.11 | 0.56 | 0.06 | 0.11 |
| 0.04 | 0.02 | 0.56 | 0.04 | 0.03 | 0.04 | 0.11 | 0.56 |

| Left | | Right | | Top | | | Below | | |
|---|---|---|---|---|---|---|---|---|---|
| 0.11 | 0.03 | 0.06 | 0.11 | 0.11 | 0.56 | 0.04 | 0.06 | 0.11 | 0.03 |
| 0.56 | 0.04 | 0.11 | 0.56 | 0.03 | 0.04 | 0.02 | 0.11 | 0.56 | 0.04 |
| 0.04 | 0.02 | 0.03 | 0.04 | | | | | | |

The calculation of the reference filtering parameters of each sub-pixel under the 1×3 filter is similar to the calculation of the reference filtering parameters of each sub-pixel under the 3×3 filter.

In this way, through the operations in the above embodiments, all possible filtering parameters of each pixel, i.e., reference filtering parameters, can be calculated.

In an embodiment, determining the display state of each pixel based on the brightness differences between each pixel and the adjacent pixels includes: calculating the brightness differences between each pixel and the adjacent pixels in a preset direction, the adjacent pixels being determined based on a preset pixel window; and performing encoding according to the brightness differences to obtain encoding information, and obtaining the display state based on the encoding information.

The preset direction includes horizontal direction, vertical direction, upper left to lower right direction, and upper right to lower left direction.

Optionally, the adjacent pixels for calculating the brightness difference in respective preset directions are different, so it is necessary to select target pixels for calculation from the adjacent pixels for each preset direction, and then calculate the brightness differences between the target pixels.

Exemplarily, with reference to FIG. 5, the target pixels in the horizontal direction include pixels numbered “3”, “4”, and “5”, the target pixels in the vertical direction include pixels numbered “1”, “4”, and “7”, the target pixels in the upper left to lower right direction include pixels numbered “0”, “4”, and “8”, and the target pixels in the upper right to lower left direction include pixels numbered “2”, “4”, and “6”.

The brightness differences between the target pixels in different preset directions are calculated, and then encoding is performed according to the brightness differences to obtain the encoding information. By performing encoding on the pixel, the brightness relationship between the pixel and the adjacent pixels can be converted into structured data, which can intuitively determine the display state.

Furthermore, the brightness differences between the target pixels in each preset direction are calculated. Exemplarily, taking the horizontal direction as an example, the brightness difference between the pixel numbered “3” and the pixel numbered “4” is calculated first, and then the brightness difference between the pixel numbered “4” and the pixel numbered “5” is calculated. The calculation of brightness differences in other directions is similar.

Furthermore, performing encoding according to the brightness differences to obtain the encoding information, and obtaining the display state based on the encoding information, includes: comparing the brightness differences with a preset threshold to obtain difference information; performing encoding on each pixel and the adjacent pixels corresponding to each pixel based on the difference information to obtain the encoding information; and comparing the encoding information with preset encoding information to obtain the display state.

Optionally, the differences between the pixels in each preset direction are compared with the preset threshold to obtain the difference information. The preset threshold is a preset value for distinguishing whether the brightness difference is sufficiently obvious.

Optionally, if the brightness difference is greater than the preset threshold, it is determined that the brightness variation in the corresponding direction is significant, and that there is a color edge or jagged problem in the direction. In this case, the direction is marked as “1” in the encoding information. Conversely, if the brightness difference is less than or equal to the preset threshold, it is determined that the brightness variation in the corresponding direction is not significant, and the region in this direction may be a smooth region. In this case, the direction is marked as “0” in the encoding information, so that the encoding information in each preset direction can be obtained.

Furthermore, the display state of the pixel block is determined by comparing the encoding information with the preset encoding information. The preset encoding information includes preset edge encoding information and preset jaggy encoding information, which are respectively configured to determine whether the pixel block has an edge-shaped anomaly or a jagged anomaly.

Exemplarily, assuming that the display states of respective pixel blocks are known, the preset edge encoding information and the preset jaggy information are generated based on the encoding information of the pixel blocks, i.e., the preset edge encoding information and the preset jaggy encoding information are generated by using prior knowledge.

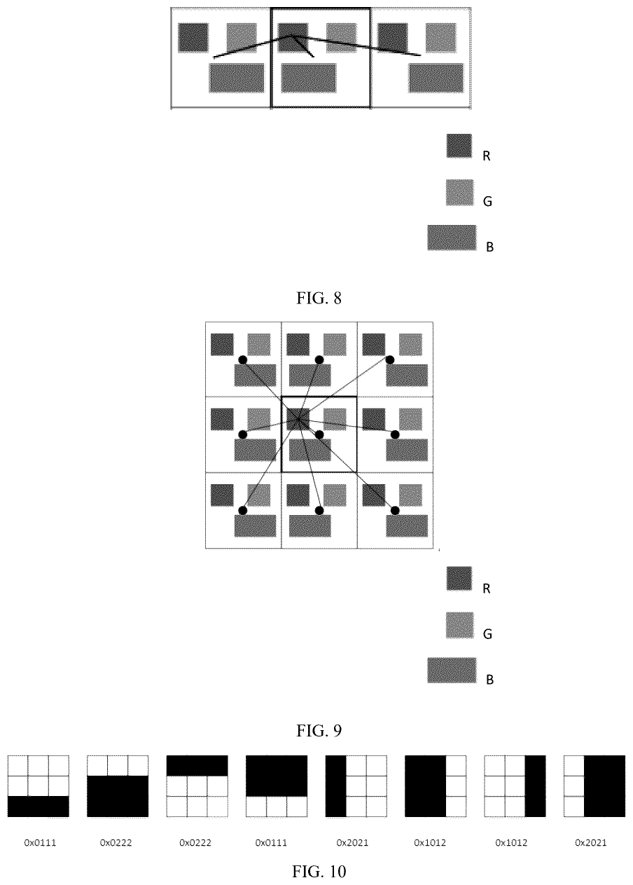

Exemplarily, with reference to FIG. 10, FIG. 10 is a schematic diagram showing an edge-shaped anomaly in an embodiment. FIG. 10 presents a variety of edge-shaped anomalies and encoding information corresponding to the edge-shaped anomalies. The encoding information corresponding to the edge-shaped anomalies is taken as the preset edge encoding information, and the preset edge encoding information is denoted as [0x0111, 0x0222, 0x2021, 0x1012].

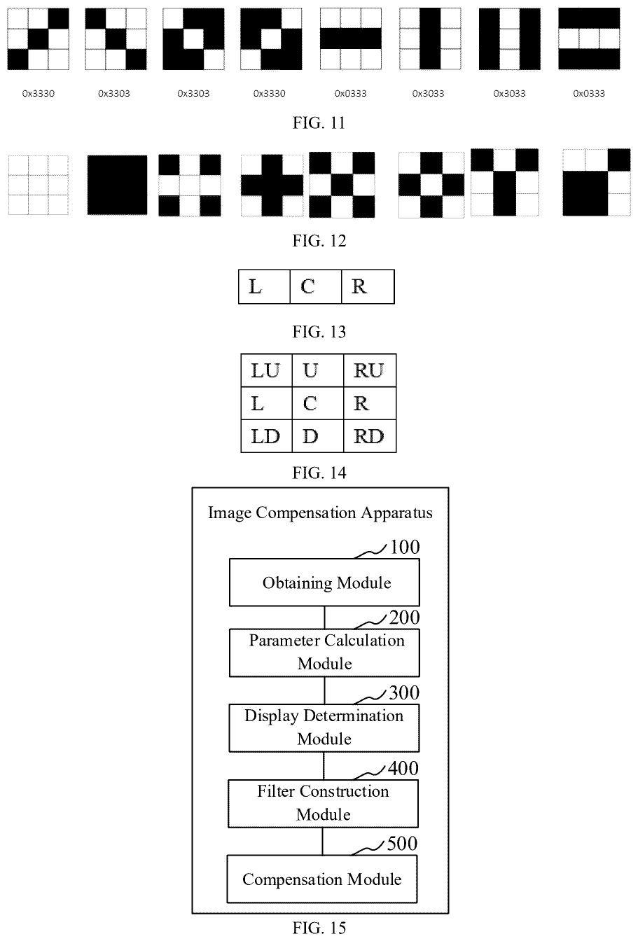

Exemplarily, with reference to FIG. 11, FIG. 11 is a schematic diagram showing a jagged anomaly in an embodiment. Similarly, FIG. 11 presents a variety of jagged anomalies and encoding information corresponding to the jagged anomalies. The encoding information corresponding to the jagged anomalies is taken as the preset edge encoding information, and the preset jaggy encoding information is denoted as [0x03330, 0x3303, 0x0333, 0x3033].

After the encoding information corresponding to each pixel block is obtained, the encoding information is compared with the preset encoding information to obtain the corresponding display state.

Exemplarily, when the encoding information belongs to [0x0111, 0x0222, 0x2021, 0x1012], the display state is determined to be the edge-shaped anomaly. When the encoding information belongs to [0x03330, 0x3303, 0x0333, 0x3033], the display state is determined to be the jagged anomaly.

In this way, by comparing the encoding information with the preset encoding information, the display state can be determined simply and quickly.

If the encoding information is different from both the preset edge encoding information and the preset jaggy encoding information, it is determined that the display state is other display states. Exemplarily, FIG. 12 is a schematic diagram showing other display states in an embodiment.

In an embodiment, constructing the target filter for each pixel based on the display state and the reference filtering parameters includes: obtaining a first original filter; adjusting the first original filter according to the display state to obtain a first initial filter; selecting first target filtering parameters from the reference filtering parameters based on the first initial filter; and obtaining the target filter according to the first initial filter and the first target filtering parameters.

Exemplarily, the first original filter is as shown in formula (3):

$$filter = ( 1 - {blend}_{ratio} ) ⨯ {filter}_{1 ⨯ 3} + {blend}_{ratio} ⨯ {filter}_{3 ⨯ 3} \qquad Formula ( 3 )$$

The first original filter includes a 1×3 filter filter_{1×3} and a 3×3 filter filter_{3×3} . Using two preset filter structures can effectively solve different types of display problems.

Then, the current sub-pixel value adjusted by the first original filter is as shown in formula (4).

$$data = ( 1 - {blend}_{ratio} ) ⨯ ( {filter}_{1 ⨯ 3} ⊗ {block}_{1 ⨯ 3} ) + {blend}_{ratio} ⨯ ( {filter}_{3 ⨯ 3} ⊗ {block}_{3 ⨯ 3} ) \qquad Formula ( 4 )$$

Optionally, the first original filter is adjusted by changing the parameter blendᵣₐₜᵢₒ based on the display state to obtain the first initial filter capable of filtering based on the display state.

Optionally, the first original filter includes a first-order filter and a third-order filter, and adjusting the first original filter according to the display state to obtain the first initial filter includes: selecting the first-order filter as the first initial filter when the display state is the edge-shaped anomaly; selecting the third-order filter as the first initial filter when the display state is the jagged anomaly; and selecting a hybrid filter as the first initial filter when the display state is neither in the edge shape nor in the jagged shape.

Optionally, coefficients of the first-order filter and the third-order filter in the first original filter are adjusted based on the display state to obtain the first initial filter.

Exemplarily, when the display state is the edge-shaped anomaly, blendᵣₐₜᵢₒ in formula (3) is set to 0, and the 1×3 filter filter_{1×3} is used, i.e., the first-order filter is selected as the first initial filter. Since the edge-shaped anomaly mainly refers to the variation in a single direction, the first-order filter is configured to perform smoothing on the brightness or color variation in one direction of the edge, thereby reducing color fringing.

Exemplarily, when the display state is the jagged anomaly, blendᵣₐₜᵢₒ in formula (3) is set to 1, and the 3×3 filter filter_{3×3} is used, i.e., the third-order filter is taken as the first initial filter. Since the jagged anomaly refers to edges in multiple directions, the third-order filter is configured to perform smoothing on the brightness or color variations in multiple directions, thereby eliminating the jaggy staircase effect.

When the display state is in other states, i.e., when the display state is neither the edge-shaped anomaly nor in jagged anomaly, blendᵣₐₜᵢₒ in formula (3) is set to, for example, 0.5 to achieve a balance between filter_{1×3} and filter_{3×3}.

In the above embodiment, the reference filtering parameters include multiple groups of filtering parameters, i.e., the first-order filtering parameters and the third-order filtering parameters. Therefore, after the first initial filter is determined, the first target filtering parameters are selected from the reference filtering parameters based on the first initial filter. In other words, one or more groups of filtering parameters are selected from the first-order filtering parameters and the third-order filtering parameters as the first target filtering parameters, thereby obtaining the target filter. When the display state is neither the edge-shaped anomaly nor the jagged anomaly, two groups of filtering parameters are simultaneously selected as the first target filtering parameters.

Furthermore, two different parameter configurations are calculated for each group of filtering parameters, i.e., filtering parameters are calculated when the sub-pixel is located at the first preset position and the second preset position. Therefore, further selection is performed based on the arrangement of sub-pixels in each pixel.

In an embodiment, selecting the first target filtering parameters from the reference filtering parameters based on the first initial filter includes: selecting initial filtering parameters from the reference filtering parameters based on the first initial filter; and selecting the first target filtering parameters from the initial filtering parameters based on the arrangement of sub-pixels in each pixel.

In this embodiment, the filtering parameters selected based on the structure of the first initial filter are taken as first initial filtering parameters. With reference to the examples in the above embodiments, the first initial filtering parameters may be the first-order filtering parameters and/or the third-order filtering parameters.

Then, the first target filtering parameters are selected from the initial filtering parameters based on the arrangement of the sub-pixels in the pixels.

Further, the first target filtering parameters are selected from the first initial filtering parameters based on whether the sub-pixel is located at the first preset position or the second preset position.

In another embodiment, another method for constructing the target filter for each pixel based on the display state and the reference filtering parameters is provided, including: obtaining a second original filter; obtaining a second initial filter based on the second original filter and the reference filtering parameters; and adjusting the second initial filter according to the display state to obtain the target filter.

In this embodiment, it should be noted that the second original filter and the second initial filter are only used to distinguish two ways of constructing the target filter. Since the steps in this embodiment are similar to those in the previous embodiment, the detailed steps will not be described in this embodiment.

The second original filter is shown in formula (3). After the second original filter is obtained, the second initial filter is obtained based on the first-order filtering parameters and the third-order filtering parameters in the reference filtering parameters.

Since the first-order filtering parameters and the third-order filtering parameters each include two groups of parameters, obtaining the second initial filtering parameters based on the reference filtering parameters and the original filter includes: selecting second initial filtering parameters from the reference filtering parameters based on an arrangement of sub-pixels in each pixel; and obtaining the second initial filter based on the original filter and the second initial filtering parameters.

In other words, based on the actual arrangement of sub-pixels, a group of parameters is selected from the two groups of parameters corresponding to the first-order filtering parameters and the third-order filtering parameters as the second initial filtering parameters, and then the second initial filter is obtained based on the second initial filtering parameters and the second original filter.

After the second initial filter is obtained, the second initial filter is adjusted according to the display state to obtain the target filter.

The second original filter includes a first-order filter and a third-order filter, and adjusting the second initial filter according to the display state to obtain the target filter includes: selecting the first-order filter as the second initial filter when the display state is the edge-shaped anomaly; selecting the third-order filter as the second initial filter when the display state is the jagged anomaly; and selecting the first-order filter and the multi-order filter as the second initial filter when the display state is neither the edge-shaped anomaly nor the jagged anomaly.

Optionally, coefficients of the first-order filter and the third-order filter in the second original filter are adjusted based on the display state to obtain the target filter.

In an embodiment, after the target filter is obtained, the target filter is configured to compensate the image to be processed.

Exemplarily, when the first-order filter is applied, the image to be processed may be compensated according to the following formula (5).

$${filter}_{1 ⨯ 3} ( P ) = {R}_{L} * {P}_{L} + {R}_{C} * {P}_{C} + {R}_{R} * {P}_{R} \qquad Formula ( 5 )$$

With reference to FIG. 13, P_{L} represents the brightness value of the pixel on the left, P_{C} represents the brightness value of the central pixel, and P_{R} represents the brightness value of the pixel on the right. The weights corresponding to R_{L}, R_{C} and R_{R} are the weights obtained in the above embodiment.

Exemplarily, when the third-order filter is applied, the image to be processed may be compensated according to the following formula (6).

$$Formula ( 6 )$$

$${filter}_{3 ⨯ 3} ( P ) = {R}_{L U} * {P}_{L U} + {R}_{U} * {P}_{U} + {R}_{R U} * {P}_{R U} + {R}_{L} * {P}_{L} + {R}_{C} * {P}_{C} + {R}_{R} * {P}_{R} + {R}_{L D} * {P}_{L D} + {R}_{D} * {P}_{D} + {R}_{R D} * {P}_{R D}$$

With reference to FIG. 14, P_{LU}, P_{U}, P_{RU}, . . . , represent the brightness values of the pixel on the upper left, upper, upper right and other directions, respectively. R_{LU}, R_{U}, R_{RU}, . . . , represent the corresponding weights, respectively.

The brightness value of the sub-pixel after compensation is shown in formula (7):

$$Formula ( 7 )$$

$$f i l t e r ( P ) = ( 1 - b l e n {d}_{ra𝔱io} ) * {filter}_{1 ⨯ 3} ( P ) + blen {d}_{ra𝔱io} * {filter}_{3 ⨯ 3} ( P )$$

where blendᵣₐₜᵢₒ is as described in the above embodiment, details are not be described here.

It should be understood that although the individual steps in the flow charts involved in the embodiments as described above are shown sequentially as indicated by arrows, the steps are not necessarily performed sequentially in the order indicated by the arrows. Unless explicitly stated herein, the execution of these steps is not strictly limited in any order and these steps can be performed in any other order. Moreover, at least some of the steps in the flow charts involved in the embodiments as described above may include multiple sub-steps or multiple stages that are not necessarily performed simultaneously, but may be performed at different moments. The order in which these sub-steps or stages are performed is not necessarily sequential, and these sub-steps or stages may be performed in turn or alternately with at least some of other steps or at least some of sub-steps or stages in other steps.

Based on the same inventive concept, embodiments of the present disclosure also provide an image compensation apparatus for implementing the image compensation method as described above. The solution to the problem provided by the apparatus is similar to the implementation of the method documented above, so the specific features in the one or more embodiments of the image compensation apparatus provided below may be understood with reference to the features of the image compensation method above and will not be repeated here.

In an exemplary embodiment, as shown in FIG. 15, an image compensation apparatus is provided, including: an obtaining module 100, a parameter calculation module 200, a display determination module 300, a filter construction module 400 and a compensation module 500.

The obtaining module 100 is configured to obtain an image to be processed.

The parameter calculation module 200 is configured to calculate reference filtering parameters of each pixel in the image to be processed based on a positional relation between each pixel and reference pixels corresponding to each pixel.

The display determination module 300 is configured to determine a display state of each pixel based on brightness differences between each pixel and adjacent pixels.

The filter construction module 400 is configured to construct a target filter for each pixel based on the display state and the reference filtering parameters.

The compensation module 500 is configured to adjust a brightness value of each pixel through the target filter.

In an embodiment, the parameter calculation module 200 includes:
a reference pixel determination unit configured to determine the reference pixels corresponding to each pixel; and
a distance calculation unit configured to calculate geometric distances from a geometric center of each sub-pixel in each pixel to a geometric center of the current pixel and a geometric center of each of the reference pixels, respectively, to obtain the reference filtering parameters.

In an embodiment, the distance calculation unit includes:
a distance weighting subunit configured to calculate a weighted distance corresponding to each sub-pixel based on the geometric distances from the geometric center of each sub-pixel in each pixel to the geometric center of the current pixel and the geometric center of each of the reference pixels; and
a first parameter calculation subunit configured to obtain the reference filtering parameters based on a proportion of the geometric distance from each sub-pixel in each pixel to the current pixel in the weighted distance.

In an embodiment, the distance calculation unit further includes: a second parameter calculation subunit configured to calculate distances from each sub-pixel in each pixel at a first preset position to the geometric center of the current pixel and the geometric center of each of the reference pixels, respectively, and calculate distances from each sub-pixel in each pixel at a second preset position to the geometric center of the current pixel and the geometric center of each of the reference pixels, respectively, to obtain the reference filtering parameters when an arrangement of sub-pixels in the pixel is different from an arrangement of sub-pixels in each of the reference pixels.

In an embodiment, the display determination module 300 includes:
a difference calculation unit configured to calculate the brightness differences between each pixel and the adjacent pixels in a preset direction, the adjacent pixels being determined based on a preset pixel window; and
an encoding unit configured to perform encoding according to the brightness differences to obtain encoding information, and obtain the display state based on the encoding information.

In an embodiment, the encoding unit includes:
a difference calculation subunit configured to compare the brightness differences with a preset threshold to obtain difference information;
an encoding subunit configured to perform encoding on each pixel and the adjacent pixels corresponding to each pixel based on the difference information to obtain the encoding information; and
a comparison subunit configured to compare the encoding information with preset encoding information to obtain the display state.

In an embodiment, the parameter calculation module 200 includes:
a first filter obtaining unit configured to obtain a first original filter;
a first filter adjustment unit configured to adjust the first original filter according to the display state to obtain a first initial filter;
a first parameter selection unit configured to select first target filtering parameters from the reference filtering parameters based on the first initial filter; and
a first filter construction unit configured to obtain the target filter by combining the first initial filter and the first target filtering parameters.

In an embodiment, the first filter construction unit includes:
a first determination subunit configured to select the first-order filter as the first initial filter when the display state is the edge-shaped anomaly;
a second determination subunit configured to select the third-order filter as the first initial filter when the display state is the jagged anomaly; and
a third determination subunit configured to select the first-order filter and the third-order filter as the first initial filter when the display state is neither in the edge-shaped anomaly nor in the jagged anomaly.

In an embodiment, the parameter selection unit includes:
a first initial parameter selection subunit configured to select initial filtering parameters from the reference filtering parameters based on a structure of the first initial filter; and
a first target parameter selection subunit configured to select the first target filtering parameters from the initial filtering parameters based on an arrangement of sub-pixels in each pixel.

In an embodiment, the parameter calculation module 200 includes:
a second filter obtaining unit configured to obtain a second original filter;
a second filter construction unit configured to obtain a second initial filter based on the second original filter and the reference filtering parameters; and
a second filter adjustment unit configured to adjust the second initial filter according to the display state to obtain the target filter.

In an embodiment, the second filter adjustment unit includes:
a fourth determination subunit configured to select the first-order filter as the second initial filter when the display state is the edge-shaped anomaly;
a fifth determination subunit configured to select the third-order filter as the second initial filter when the display state is the jagged anomaly; and
a sixth determination subunit configured to select the first-order filter and the third-order filter as the second initial filter when the display state is neither the edge-shaped anomaly nor the jagged anomaly.

In an embodiment, the second filter construction unit includes:
a second initial parameter selection subunit configured to select second initial filtering parameters from the reference filtering parameters based on an arrangement of sub-pixels in each pixel;
the first target parameter selection subunit configured to select the first target filtering parameters from the initial filtering parameters based on an arrangement of sub-pixels in each pixel; and
a second initial filter determination subunit configured to obtain the second initial filter based on the original filter and the second initial filtering parameters.

The individual modules in the above image compensation apparatus can be implemented in whole or in part by software, hardware and combinations thereof. Each of the above modules may be embedded in hardware form or independent of a processor in a computer device, or may be stored in software form on a memory in the computer device so that the processor can be called to perform the operations corresponding to each of the above modules.

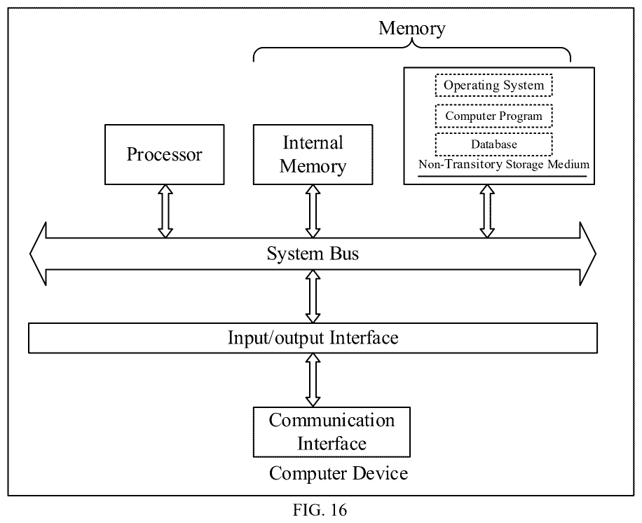

In an exemplary embodiment, a computer device is provided. The computer device may be a server. A diagram illustrating an internal configuration of the computer device may be shown in FIG. 16. The computer device includes a processor, a memory, an input/output (I/O) interface, and a communication interface. The processor, the memory and the input/output interface are connected via a system bus, and the communication interface is connected to the system bus via the input/output interface. The processor of the computer device is configured to provide computing and control capabilities. The memory of the computer device includes a non-transitory storage medium and an internal memory. The non-transitory storage medium stores operating systems, computer programs and databases. The internal memory provides an environment for the operation of the operating systems and the computer programs in the non-transitory storage medium. The databases of the computer device are configured to store image data to be processed. The input/output interface of the computer device is configured to exchange information between the processor and external devices. The communication interface of the computer device is configured to communicate with external terminals via a network connection. When the computer programs are executed by the processor, the image compensation method is implemented.

It should be understood by a person of ordinary skill in the art that the configuration illustrated in FIG. 16 is only a block diagram of part of the configuration related to the solution of the present disclosure, and does not constitute a limitation on the computer device to which the solution of the present disclosure is applied. Specifically, the computer device may include more or less components than those shown in the figure, or may combine some components, or may have a different arrangement of components.

In an exemplary embodiment, a computer device is provided, including a memory and a processor. The memory stores a computer program, and the processor, when executing the computer program, implements the steps of the method in any one of the above embodiments.

In an embodiment, a non-transitory computer-readable storage medium is provided, having a computer program stored thereon. When the computer program is executed by a processor, the steps of the method in any one of the above embodiments are implemented.

In an embodiment, when the computer program is executed by a processor, the steps of the method in any one of the above embodiments are implemented.

A person of ordinary skill in the art may understand that implementation of all or part of the processes in the methods of the above embodiments may be completed by instructing the relevant hardware through a computer program. The computer program may be stored in a non-transitory computer-readable storage medium. When the computer program is executed, it may include the processes of the respective methods according to the foregoing embodiments. Any reference to memory, database or other medium used of the embodiments provided in the present disclosure may include at least one of a non-transitory or a transitory memory. The non-transitory memory may include a read-only memory (ROM), a magnetic tape, a floppy disk, a flash memory, an optical memory, a high-density embedded non-transitory memory, a resistive random-access memory (ReRAM), a magneto resistive random-access memory (MRAM), a ferroelectric random-access memory (FRAM), a phase change memory (PCM), or a graphene memory, etc. The transitory memory may include a random-access memory (RAM) or an external cache memory, etc. As an illustration rather than a limitation, the random-access memory may be in various forms, such as a static random-access memory (SRAM) or a dynamic random-access memory (DRAM), etc. The databases involved in the embodiments provided by the present disclosure may include at least one of a relational database and a non-relational database. The non-relational database may include, but is not limited to, a blockchain-based distributed database, etc. The processor involved in the embodiments provided by the present disclosure may be, but is not limited to, a general purpose processor, a central processor, a graphics processor, a digital signal processor, a programmable logic device, a data processing logic device based on quantum computation, an artificial intelligence (AI) processor, and the like.

The technical features in the above embodiments may be combined arbitrarily. For concise description, not all possible combinations of the technical features in the above embodiments are described. However, provided that they do not conflict with each other, all combinations of the technical features are to be considered to be within the scope of protection of the present disclosure.

The above-mentioned embodiments only describe several implementations of the present disclosure, and their description is specific and detailed, but should not be understood as a limitation on the protection scope of the present disclosure. It should be noted that, for a person of ordinary skill in the art, various variations and improvements can be further made without departing from the conception of the present disclosure, and these all fall within the protection scope of the present disclosure. Therefore, the protection scope of the present disclosure should be subject to the appended claims.

What is claimed is:

1. An image compensation method, comprising:
obtaining an image to be processed;
calculating reference filtering parameters of each pixel in the image to be processed based on a positional relation between each pixel and reference pixels corresponding to each pixel;
determining a display state of each pixel based on brightness differences between each pixel and adjacent pixels;
constructing a target filter for each pixel based on the display state and the reference filtering parameters; and
adjusting a brightness value of each pixel through the target filter.

2. The image compensation method of claim 1, wherein calculating the reference filtering parameters of each pixel in the image to be processed based on the positional relation between each pixel and the reference pixels corresponding to each pixel comprises:
determining the reference pixels corresponding to each pixel; and
calculating geometric distances from a geometric center of each sub-pixel in each pixel to a geometric center of a current pixel and a geometric center of each of the reference pixels, respectively, to obtain the reference filtering parameters.

3. The image compensation method of claim 2, wherein calculating the geometric distances from the geometric center of each sub-pixel in each pixel to the geometric center of the current pixel and the geometric center of each of the reference pixels, respectively, to obtain the reference filtering parameters comprises:
calculating a weighted distance corresponding to each sub-pixel based on the geometric distances from the geometric center of each sub-pixel in each pixel to the geometric center of the current pixel and the geometric center of each of the reference pixels; and
obtaining the reference filtering parameters based on a proportion of the geometric distance from the geometric center of each sub-pixel in each pixel to the geometric center of the current pixel in the weighted distance.

4. The image compensation method of claim 2, wherein calculating the geometric distances from the geometric center of each sub-pixel in each pixel to the geometric center of the current pixel and the geometric center of each of the reference pixels, respectively, to obtain the reference filtering parameters comprises:
when an arrangement of sub-pixels in the current pixel is different from an arrangement of sub-pixels in each of the reference pixels, calculating distances from each sub-pixel in each pixel at a first preset position to the geometric center of the current pixel and the geometric center of each of the reference pixels, respectively, and calculating distances from each sub-pixel in each pixel at a second preset position to the geometric center of the current pixel and the geometric center of each of the reference pixels, respectively, to obtain the reference filtering parameters.

5. The image compensation method of claim 1, wherein determining the display state of each pixel based on the brightness differences between each pixel and the adjacent pixels comprises:
calculating the brightness differences between each pixel and the adjacent pixels in a preset direction, the adjacent pixels being determined based on a preset pixel window; and
performing encoding according to the brightness differences to obtain encoding information, and obtaining the display state based on the encoding information.

6. The image compensation method of claim 5, wherein performing encoding according to the brightness differences to obtain the encoding information, and obtaining the display state based on the encoding information comprises:
comparing the brightness differences with a preset threshold to obtain difference information;
performing encoding on each pixel and the adjacent pixels corresponding to each pixel based on the difference information to obtain the encoding information; and
comparing the encoding information with preset encoding information to obtain the display state.

7. The image compensation method of claim 1, wherein constructing the target filter for each pixel based on the display state and the reference filtering parameters comprises:
obtaining a first original filter;
adjusting the first original filter according to the display state to obtain a first initial filter;
selecting first target filtering parameters from the reference filtering parameters based on the first initial filter; and
obtaining the target filter according to the first initial filter and the first target filtering parameters.

8. The image compensation method of claim 7, wherein the first original filter comprises a first-order filter and a third-order filter, and adjusting the first original filter according to the display state to obtain the first initial filter comprises:
selecting the first-order filter as the first initial filter when the display state is an edge-shaped anomaly;
selecting the third-order filter as the first initial filter when the display state is a jagged anomaly; and
selecting the first-order filter and the third-order filter as the first initial filter when the display state is neither the edge-shaped anomaly nor the jagged anomaly.

9. The image compensation method of claim 7, wherein selecting the first target filtering parameters from the reference filtering parameters based on the first initial filter comprises:
selecting initial filtering parameters from the reference filtering parameters based on a structure of the first initial filter; and
selecting the first target filtering parameters from the initial filtering parameters based on an arrangement of sub-pixels in each pixel.

10. The image compensation method of claim 1, wherein constructing the target filter for each pixel based on the display state and the reference filtering parameters comprises:
obtaining a second original filter;
obtaining a second initial filter based on the second original filter and the reference filtering parameters; and
adjusting the second initial filter according to the display state to obtain the target filter.

11. The image compensation method of claim 10, wherein the second original filter comprises a first-order filter and a third-order filter, and adjusting the second initial filter according to the display state to obtain the target filter comprises:
selecting the first-order filter as the second initial filter when the display state is an edge-shaped anomaly;
selecting the third-order filter as the second initial filter when the display state is a jagged anomaly; and
selecting the first-order filter and the third-order filter as the second initial filter when the display state is neither the edge-shaped anomaly nor the jagged anomaly.

12. The image compensation method of claim 10, wherein obtaining the second initial filter based on the second original filter and the reference filtering parameters comprises:
selecting second initial filtering parameters from the reference filtering parameters based on an arrangement of sub-pixels in each pixel; and
obtaining the second initial filter based on the original filter and the second initial filtering parameters.

13. A computer device comprising a memory and a processor, the memory storing a computer program, wherein the processor, when executing the computer program, implements steps of an image compensation method, the method comprising:
obtaining an image to be processed;
calculating reference filtering parameters of each pixel in the image to be processed based on a positional relation between each pixel and reference pixels corresponding to each pixel;
determining a display state of each pixel based on brightness differences between each pixel and adjacent pixels;
constructing a target filter for each pixel based on the display state and the reference filtering parameters; and
adjusting a brightness value of each pixel through the target filter.

14. The computer device of claim 13, wherein calculating the reference filtering parameters of each pixel in the image to be processed based on the positional relation between each pixel and the reference pixels corresponding to each pixel comprises:
determining the reference pixels corresponding to each pixel; and
calculating geometric distances from a geometric center of each sub-pixel in each pixel to a geometric center of a current pixel and a geometric center of each of the reference pixels, respectively, to obtain the reference filtering parameters.

15. The computer device of claim 14, wherein calculating the geometric distances from the geometric center of each sub-pixel in each pixel to the geometric center of the current pixel and the geometric center of each of the reference pixels, respectively, to obtain the reference filtering parameters comprises:
calculating a weighted distance corresponding to each sub-pixel based on the geometric distances from the geometric center of each sub-pixel in each pixel to the geometric center of the current pixel and the geometric center of each of the reference pixels; and
obtaining the reference filtering parameters based on a proportion of the geometric distance from the geometric center of each sub-pixel in each pixel to the geometric center of the current pixel in the weighted distance.

16. The computer device of claim 14, wherein calculating the geometric distances from the geometric center of each sub-pixel in each pixel to the geometric center of the current pixel and the geometric center of each of the reference pixels, respectively, to obtain the reference filtering parameters comprises:
when an arrangement of sub-pixels in the current pixel is different from an arrangement of sub-pixels in each of the reference pixels, calculating distances from each sub-pixel in each pixel at a first preset position to the geometric center of the current pixel and the geometric center of each of the reference pixels, respectively, and calculating distances from each sub-pixel in each pixel at a second preset position to the geometric center of the current pixel and the geometric center of each of the reference pixels, respectively, to obtain the reference filtering parameters.

17. The computer device of claim 13, wherein determining the display state of each pixel based on the brightness differences between each pixel and the adjacent pixels comprises:
calculating the brightness differences between each pixel and the adjacent pixels in a preset direction, the adjacent pixels being determined based on a preset pixel window; and
performing encoding according to the brightness differences to obtain encoding information, and obtaining the display state based on the encoding information.

18. The computer device of claim 17, wherein performing encoding according to the brightness differences to obtain the encoding information, and obtaining the display state based on the encoding information comprises:
comparing the brightness differences with a preset threshold to obtain difference information;
performing encoding on each pixel and the adjacent pixels corresponding to each pixel based on the difference information to obtain the encoding information; and
comparing the encoding information with preset encoding information to obtain the display state.

19. A non-transitory computer-readable storage medium having a computer program stored thereon, wherein when the computer program is executed by a processor, steps of the method of claim 1 are implemented.

20. A computer program product comprising a computer program, wherein when the computer program is executed by a processor, steps of the method of claim 1 are implemented.
